(19) United States
(12) Patent Application Publication
(10) Pub. No.: US 2010/0212839 A1
(43) Pub. Date: Aug. 26, 2010

(54) SAFETY STRUCTURE OF ROMAN SHADE

(76) Inventor: Teh-Hao Wang, Kaohsiung City (TW)

Correspondence Address: LEONG C LEI, PMB # 1008, 1867 YGNACIO VALLEY ROAD, WALNUT CREEK, CA, 94598, US

(21) Appl. No.: 12/389,374

(22) Filed: Feb. 20, 2009

(51) Int. Cl. E06B 9/24

(52) U.S. Cl. 160/84.04

(57) ABSTRACT

A safety structure is provided for a Roman shade. A shade cloth forms folds, each carrying at least one cord ring through which a lift cord that functions to raise a shade cloth up and down extends. The cord ring is made of a flexible material having a desired stiffness and is constructed to each form an end overlapped section so that when a force that exceeds weight of the shade cloth is applied to the lift cord, the overlapped section of the cord ring is broken to allow the cord ring to detach from the shade cloth.

### TECHNICAL FIELD OF THE INVENTION

The present invention generally relates to a safety structure of a Roman shade, and particularly to a safety Roman shade with enhanced safety of use.

### DESCRIPTION OF THE PRIOR ART

As shown in FIG. 1 of the attached drawings, a conventional Roman shade comprises a shade cloth 11, a head rail 12, a cord lock 13, lift cords 14 and a bottom rail 114.

The shade cloth 11 is provided with a plurality of folds 111 and each fold 111 forms a plurality of loops 112 each carrying a cord ring 113 through which the lift cord 14 extends. A bottom rail 114, which is of a substantial weight, is arranged below and attached to the shade cloth 11.

The head rail 12 is set above the shade cloth 11 and the head rail 12 supports the cord lock 13 that functions to selectively fix at least two lift cords 14.

Each lift cord 14 has an upper end extending in and along the head rail 12 and projecting out of the head rail 12 through the cord lock 13, and a lower end extending downward through the cord rings 113 that are carried by the loops 112 of the shade cloth 11 and fixed to a lower edge of the shade cloth 11.

The cord lock 13 is mounted to an end of the head rail 12 for fixing the lift cords 14 after the lift cords 14 raise up the shade cloth 11, thereby fixing the shade cloth 11 in position.

The operation of the conventional Roman shade 1 is done by pulling the lift cords 14 to raise the shade cloth 11 up or down for shading or not shading from sun light.

The conventional Roman shade 1 that has the above structure is effective is shading or not shading Sun light. However, safety problems exist for the conventional Roman shade 1. As shown in FIG. 2, since the lift cord 14 is set through the cord rings 113 carried by the loops 112 of the shade cloth 11 and the cord rings 113 are securely attached to the loops 112 and further since upper and lower ends of the lift cord 14 are respectively fixed to the cord lock 13 and the shade cloth 11, when a young child plays around where a Roman shade is located, the child can get entangled and thus tripped by the lift cord 14 and once entangling with the child, the lift cord 14 is pulled and stretches out, eventually forming a loop A which may get around the neck of the child. Since the cord ring 113 is rigid, the cord ring 113 may function as a support point B for the portion of the lift cord 14 below the loop A. This makes the loop A a lethal risk to the child. Thus, it is an important issue to be though over and overcome by the Roman shade industry as to how to eliminate the use safety concern of the conventional structure of Roman shade 1.

### SUMMARY OF THE INVENTION

The primary objective of the present invention is to provide a safety structure for a Roman shade. The Roman shade comprises a head rail, a cord lock lift cords, and a bottom rail. A shade cloth forms a plurality of folds, each carrying a plurality of cord rings. The head rail is arranged above the shade cloth and supports the cord lock. The cord lock serves to selectively fix the lift cords. The lift cord has an upper end extending through the cord lock and a lower end extending downward through the cord rings of the shade cloth to the bottom rail. The lift cord projects out of the head rail through the cord lock to be operated for raising up and down the shade cloth. The cord rings are made of a flexible material having a desired stiffness and are constructed to have each forming an end overlapped section so that when a force that exceeds weight of the shade cloth is applied to the lift cord, the overlapped section of at least one of the cord rings is broken to allow said one cord ring to detach from the shade cloth. As such, safety of operation or use of the Roman shade is ensured.

Another objective of the present invention is to provide a safety structure of a Roman shade. The Roman shade comprises a head rail, a cord lock lift cords and a bottom rail. A shade cloth forms a plurality of folds. The head rail is arranged above the shade cloth and supports the cord lock. The cord lock serves to selectively fix the lift cord. The lift cord has an upper end extending through the cord lock and a lower end extending downward through the cord rings of the shade cloth to the bottom rail. The lift cord projects out of the head rail through the cord lock to be operated for raising the shade cloth up and down. The cord rings are made of a flexible material having a desired stiffness and are constructed to have each forming an opening for fitting over and receiving and retaining a fold of the shade cloth therein in such a way that when a force that exceeds weight of the shade cloth is applied to the lift cord, the opening of at least one of the cord rings is caused to disengage from the fold to allow said one cord ring to detach from the shade cloth. As such, safety of operation or use of the Roman shade is ensured.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional Roman shade.

FIG. 2 is a perspective view illustrating the risk of use of the conventional Roman shade.

FIG. 3 is a perspective view of a Roman shade constructed in accordance with an embodiment of the present invention.

FIGS. 4 and 5 are examples of a cord ring of the Roman shade of the present invention.

FIGS. 6 and 7 are other examples of the cord ring of the Roman shade of the present invention.

FIGS. 8 and 9 are perspective views illustrating the operation of the cord ring of the present invention.

FIG. 10 is a perspective view of a Roman shade constructed in accordance with another embodiment of the present invention incorporating a cord ring of a different structure.

FIG. 11 is a perspective view of the cord ring of the embodiment of the present invention shown in FIG. 10.

FIG. 12 is a cross-sectional view of the cord ring of FIG. 10 that is set in engagement with a fold of a shade cloth of the Roman shade.

FIGS. 13 and 14 are cross-sectional views illustrating the operation of the cord ring of FIG. 10.

FIG. 15 is a perspective view of the Roman shade of the present invention, illustrating the cord ring separated from the shade cloth.

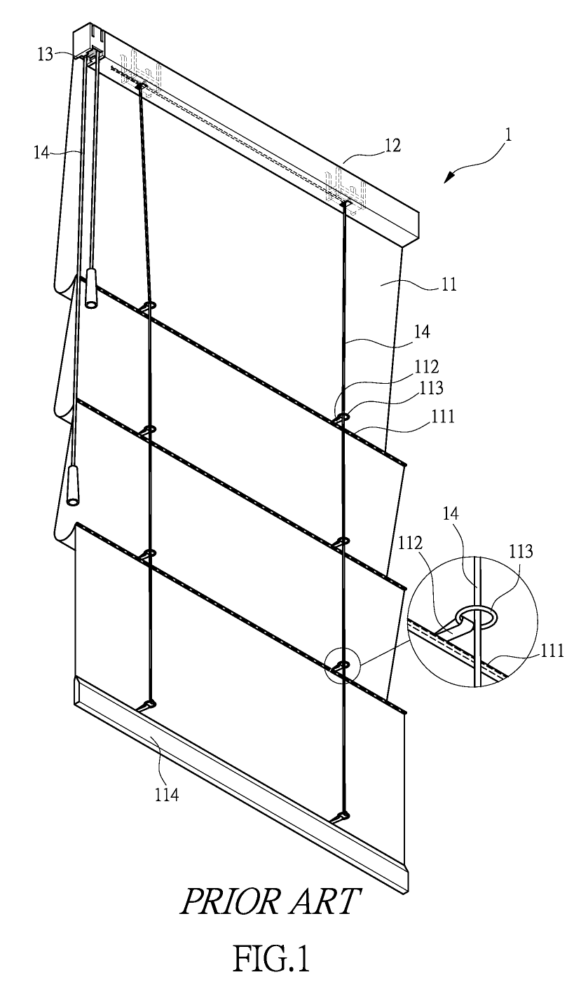

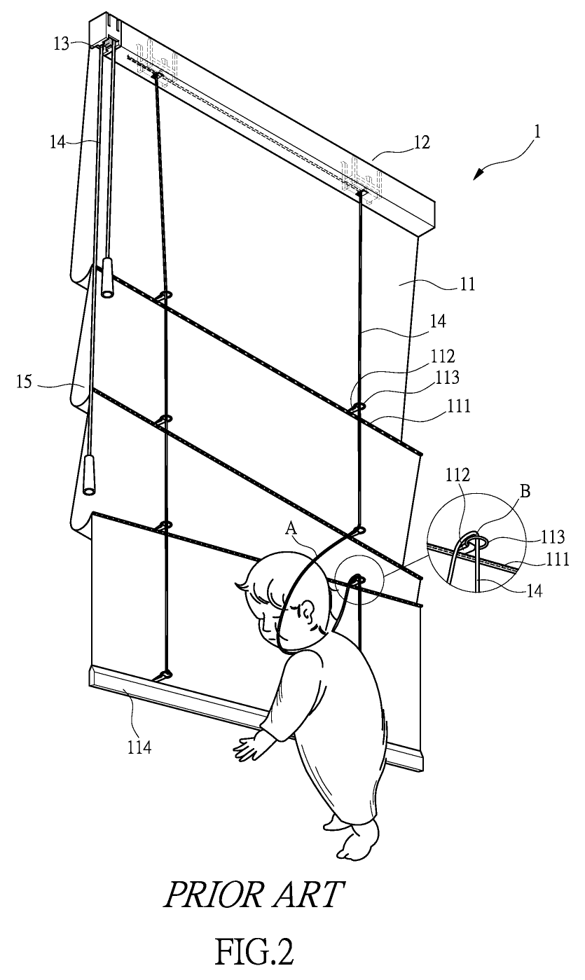

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

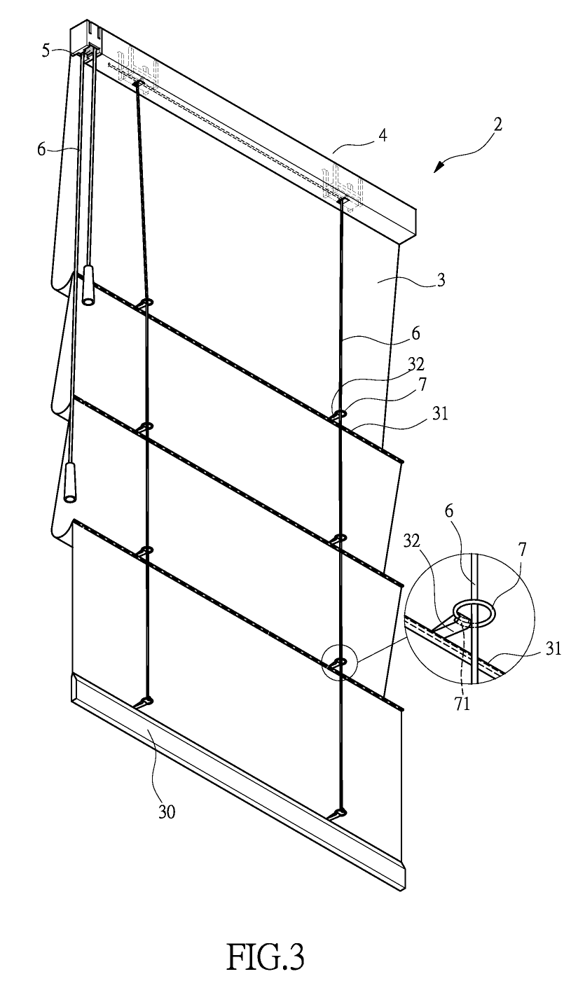

The present invention provides a safety structure of Roman shade, which is particularly illustrated in FIG. 3. The Roman shade in accordance with the present invention, generally designated at 2, comprises a shade cloth 3, a head rail 4, a cord lock 5, lift cords 6, and a bottom rail 30.

The shade cloth 3 is provided with a plurality of folds 31 and each fold 31 caries a plurality of cord rings 7. A bottom rail 30, which is of a substantial weight, is arranged below and attached to the shade cloth 3.

The head rail 4 is set above the shade cloth 3 and the head rail 4 supports the cord lock 5 that functions to withdraw and fix the lift cords 6. To allow the shade cloth 3 to be evenly raised up and down, two lift cords 6 or more are often provided.

Each lift cord 6 has an upper end extending in and along the head rail 4 and projecting out of the head rail 4 through the cord lock 5, and a lower end extending downward through the cord rings 7 of the shade cloth 3 to the bottom rail 30.

The cord lock 5 serves to fix and withdraw the lift cords 6 so as to operate the lift cords 6 to raise the shade cloth 11 up and down.

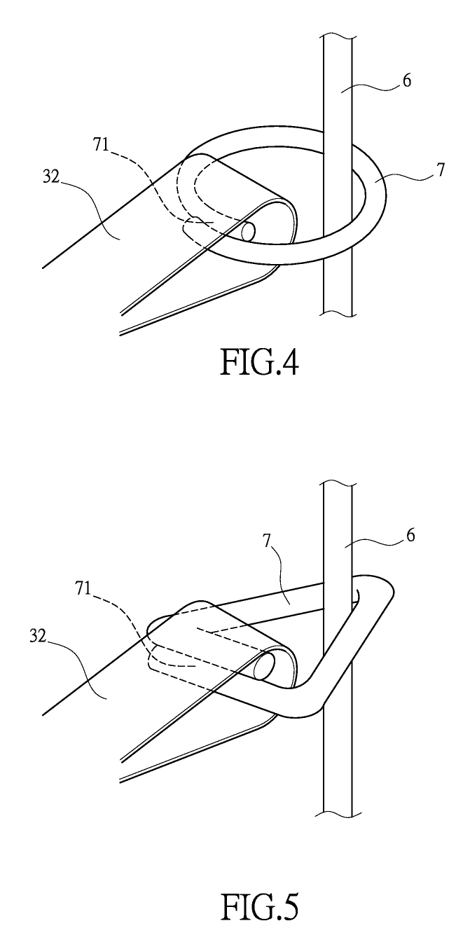

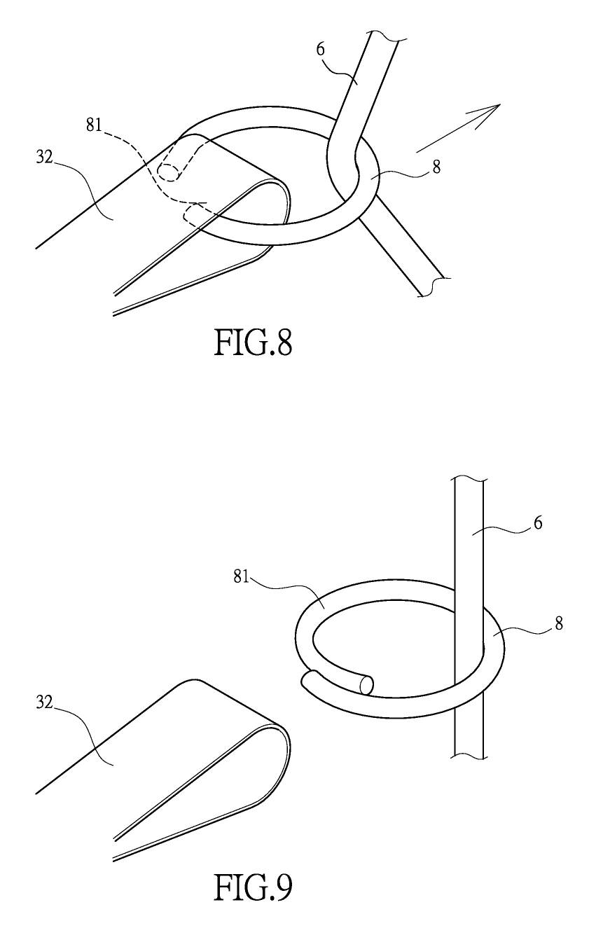

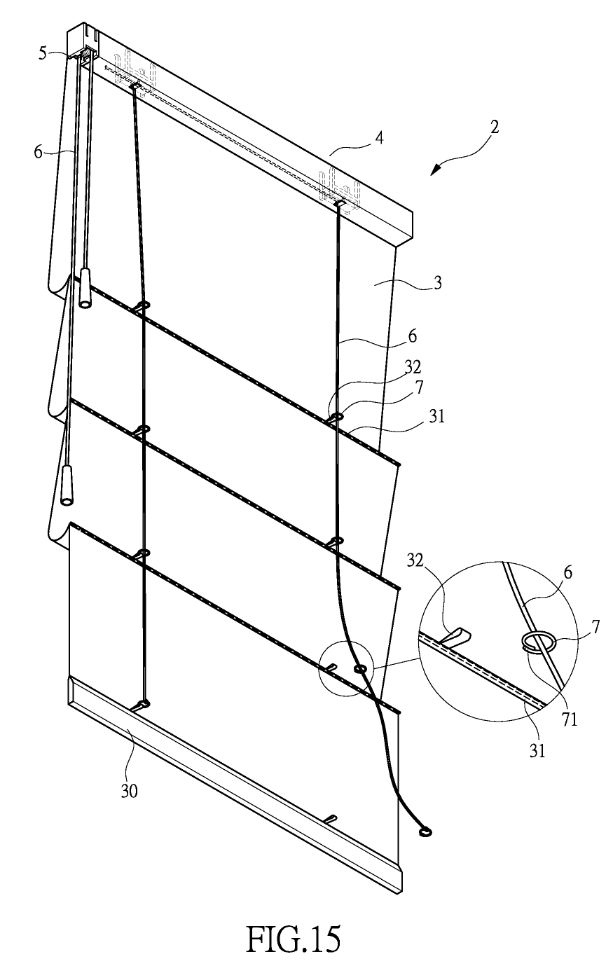

The present invention aims to improve the cord rings 7 in order to enhance the use safety of the Roman shade 2. The cord ring 7 is made of a flexible material that possesses a desired stiffness. As shown in FIGS. 4 and 5, the cord ring 7 can be made by bending an elongate bar to any desired geometric shape, such as triangle, rectangle, or circle, in such a way that an overlapped section 71 is present between opposite ends of the bar. The overlapped section 71 provides the ring 7 with sufficient stiffness to support the weight of the shade cloth 3. The cord ring 7 is coupled to a loop 32 formed on the shade cloth 3 to carry out retraction and extension of the shade cloth 3. As shown in FIGS. 8, 9, and 15, the cord ring 7 in accordance with the present invention is constructed to provide both sufficient stiffness and flexibility in such a way that the cord ring 7 is stiff enough to support the weight of the shade cloth 3 and at the same time is flexible, whereby when a young child is tripped by the lift cord 6, the body weight of the child can be sufficient to make the overlapped end section 71 of the cord ring 7 deformed and thus open, leading to separation of the cord ring 7 from the shade cloth 3. Formation of the loop A in the lift cord 6 is thus prevented and the safety of the child is ensured for no cord loop A will be formed.

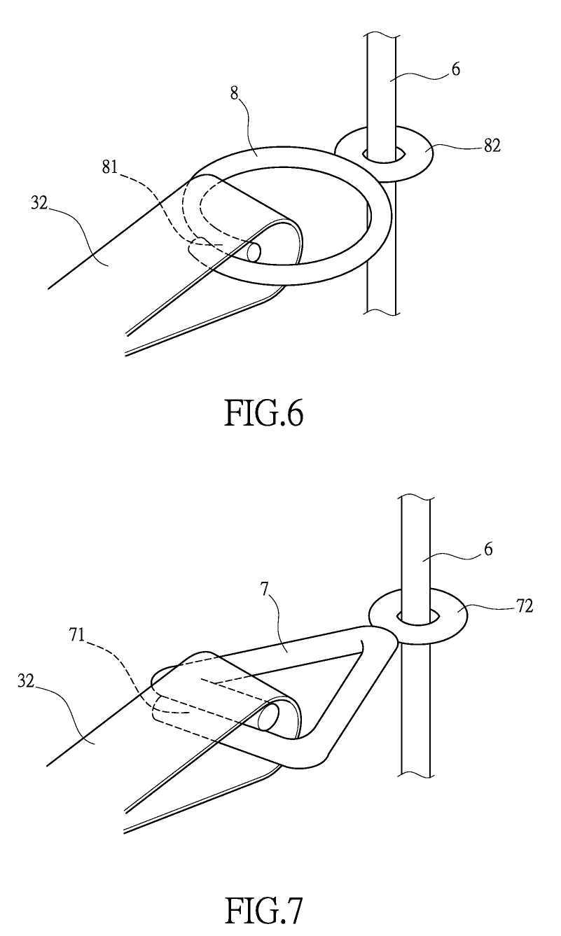

Referring to FIGS.6 and 7, the cord ring 7 can be made to include a cord hoop 72 at an outer side thereof remote from the shade cloth 3 for the extension of the lift cord 6. With the cord hoop 72, when the lift cord 6 is subjected to an undesired force, the cord ring 7 may have an extended force arm, whereby the ring 7 can more easily detach from the shade cloth 3.

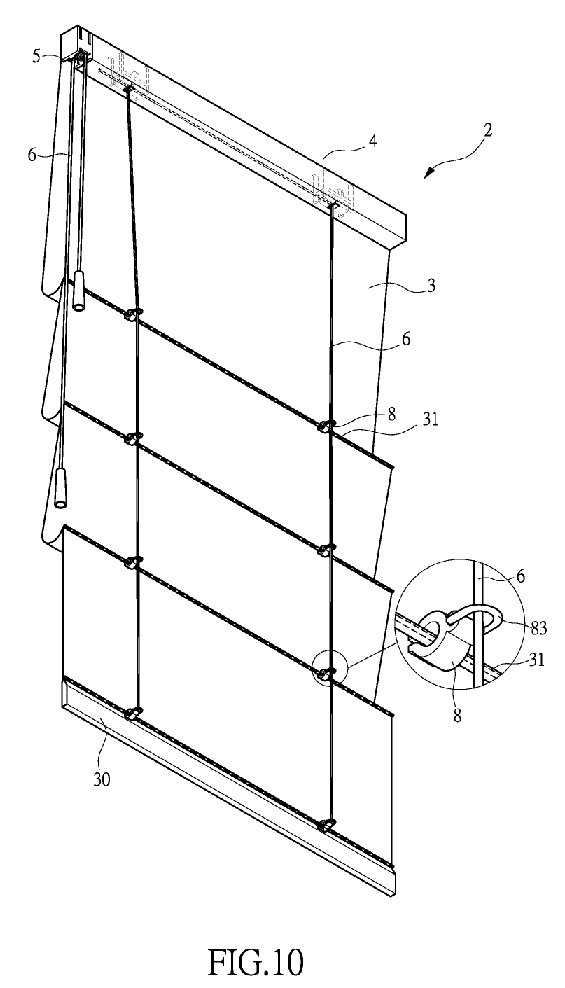

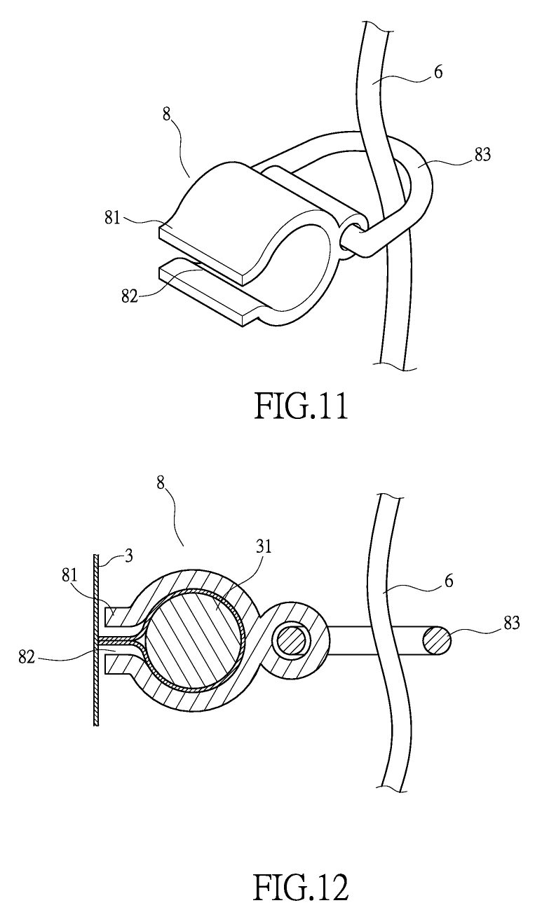

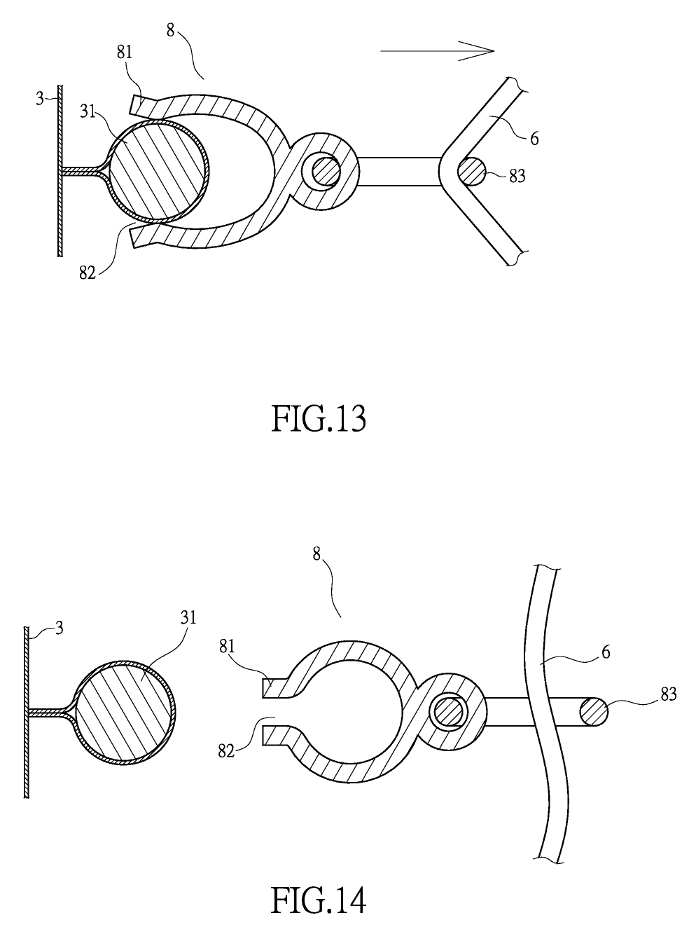

Referring to FIGS. 10, 11, and 12, the shade cloth 3 may comprise no loop 32 formed thereon and in such a case, a cord ring 8 is formed to comprises a front section that defines an opening 82 and a rear section that forms a hollow circle 83. The front section is comprised of two spaced walls having front ends flaring outwards as a lead-in portion 81 to define the opening 82. With the lead-in portion 81, the cord ring 8 may be easily fit over and thus receiving and retaining the fold 31 of the shade cloth 3 therein. The cord ring 8 is made of a material of sufficient flexibility, and the fold 31 can be securely retained between the walls of the front section of the cord ring 8. As shown in FIGS. 13 and 14, the cord ring 8 constructed in this way also possesses sufficient stiffness to support the weight of the shade cloth 3 and has sufficient flexibility to allow deformation so that when a young child is tripped by the lift cord 6, the body weight of the child is sufficient to have the opening 82 of the cord ring 8 breaking away from the fold 31 of the shade cloth 3, whereby the cord ring 8 and the lift cord 6 are detached from the shade cloth 3 and the lift cord 6 cannot form a loop A. Since no cord loop A can be formed in the lift cord 6, the safety of the child is not subjected to any risk.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A safety structure of Roman shade, wherein the Roman shade
comprises a head rail, a cord lock, lift cords, and a bottom rail;
a shade cloth forming a plurality of folds, each carrying a plurality of cord rings, a bottom rail being arranged below and attached to the shade cloth;
the head rail arranged above the shade cloth with the cord lock mounted to an end thereof, the cord lock serving to selectively fix the lift cord;
the lift cord having an upper end extending in and along the head rail and projecting out of the head rail through the cord lock, and a lower end extending downward through the cord rings of the shade cloth to the bottom rail;
whereby when the lift cord is driven, the shade cloth is raised up and down; and
wherein the cord rings are made of a flexible material having a desired stiffness and are constructed to have each forming an overlapped section so that when a force that exceeds weight of the shade cloth is applied to the lift cord, the overlapped section of at least one of the cord rings is broken to allow said one cord ring to detach from the shade cloth.

2. The safety structure according to claim 1, wherein the cord rings are formed in a geometric shape.

3. The safety structure according to claim 2, wherein the cord rings are formed in rectangle.

4. The safety structure according to claim 2, wherein the cord rings are formed in triangle.

5. The safety structure according to claim 2, wherein the cord rings are formed in circle.

6. The safety structure according to claim 2, wherein each cord ring comprises a hoop for the extension of the lift cord.

7. A safety structure of Roman shade, wherein the Roman shade
comprises a head rail, a cord lock, lift cords, and a bottom rail;
a shade cloth forming a plurality of folds, each carrying a plurality of cord rings;
the head rail arranged above the shade cloth with the cord lock mounted to an end thereof, the cord lock serving to selectively fix the lift cord;
the lift cord having an upper end extending in and along the head rail and projecting out of the head rail through the cord lock, and a lower end extending downward through the cord rings of the shade cloth to the bottom rail;
whereby when the lift cord is driven, the shade cloth is raised up and down; and
wherein the cord rings are made of a flexible material having a desired stiffness and are constructed to have each forming an opening for fitting over and receiving and retaining a fold of the shade cloth therein in such a way that when a force that exceeds weight of the shade cloth is applied to the lift cord, the opening of at least one of the cord rings is caused to disengage from the fold to allow said one cord ring to detach from the shade cloth.

8. The safety structure according to claim 7, wherein each cord ring forms a circle for the extension of the lift cord.

9. The safety structure according to claim 7, wherein the cord ring forms a lead-in portion to guide the fold of the shade cloth into the opening.
